(19) United States
(12) Patent Application Publication
(10) Pub. No.: US 2012/0060765 A1
(43) Pub. Date: Mar. 15, 2012

(54) Collapsible Cat Activity Apparatus

(76) Inventors: Doug Hough, Saint Paul, MN (US); Megan Hough, Saint Paul, MN (US)

(21) Appl. No.: 13/227,688

(22) Filed: Sep. 8, 2011

Related U.S. Application Data
(60) Provisional application No. 61/381,143, filed on Sep. 9, 2010.

(51) Int. Cl. A01K 15/02

(52) U.S. Cl. 119/706

(57) ABSTRACT

An example cat activity apparatus includes: a first frame member; a second frame member, the second frame member being attached to the first frame member at an end by a hinge mechanism to form “V” shape; a first shelf member extending between the first frame member and the second frame member, the first shelf member being positioned in notches defined by the first frame member and the second frame member; and a second shelf member extending between the first frame member and the second frame member and being vertically spaced from the first shelf member, the second shelf member being positioned in notches defined by the first frame member and the second frame member.

### BACKGROUND

There are many products on the market that are geared toward providing activities for cats. It is desirable to provide products that are easy to use and provide entertain and exercise for the cats.

### SUMMARY

A cat activity apparatus comprises frame members and shelf members. Ends of the frame members are attached to one another with a hinge mechanism. When assembled, slots in the shelf members are inserted into corresponding slots in the frame members.

### BRIEF DESCRIPTION OF THE DRAWINGS

FIG. 1 illustrates a cat activity apparatus.

FIG. 2 illustrates frame members of the cat activity apparatus.

FIG. 3 illustrates shelf members of the cat activity apparatus.

FIG. 4 is a photograph of the cat activity apparatus after assembly.

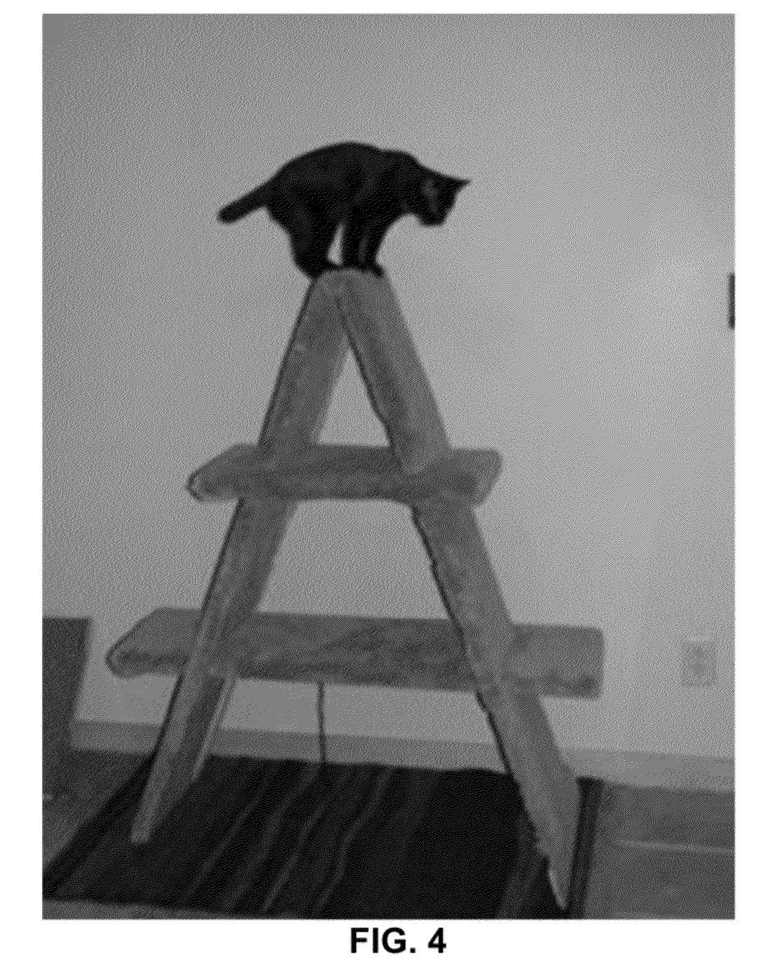

### DETAILED DESCRIPTION

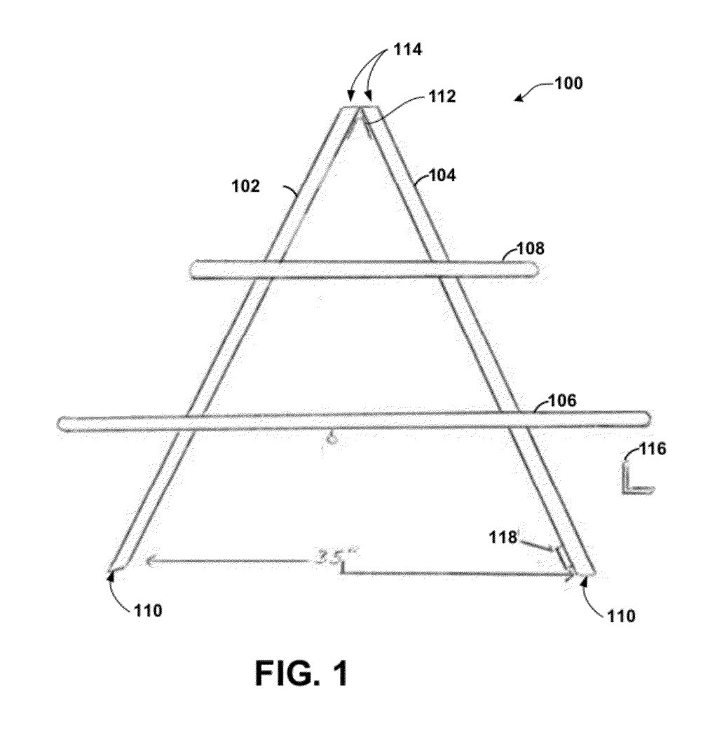

FIG. 1 illustrates a cat activity apparatus 100. The cat activity apparatus 100 is intended for use by one or more felines for entertainment and exercise, as well as entertaining their human companions. The cat activity apparatus 100 fits into a residential, shelter, or retail atmosphere. The cat activity apparatus 100 has a collapsible design. The collapsible design enables the cat activity apparatus 100 to be shipped in a relatively small carton/s and assembled easily by one person. The cat activity apparatus 100 has a multiple piece design that allows the cat activity apparatus 100 to be easily disassembled for relocation and storage.

The cat activity apparatus 100 comprises four plywood members. In some embodiments, the plywood members are ¾ inch thick. In another embodiment, the plywood members have other thicknesses. The plywood members are covered in carpeting made of various colors, styles and thicknesses.

The plywood members include frame members 102, 104 and shelf members 106, 108. In various embodiments, the frame members 102, 104 and the shelf members 106, 108 have various lengths and widths. For example, the frame members 102, 104 can be 53 inches long and eighteen inches wide. In this example, the shelf member 106 can be 43 inches long and the shelf member 108 can be 30 inches long. In this example, the shelf members 106, 108 can be 12 inches wide. In another example, the frame members 102, 104 can be thirteen inches wide.

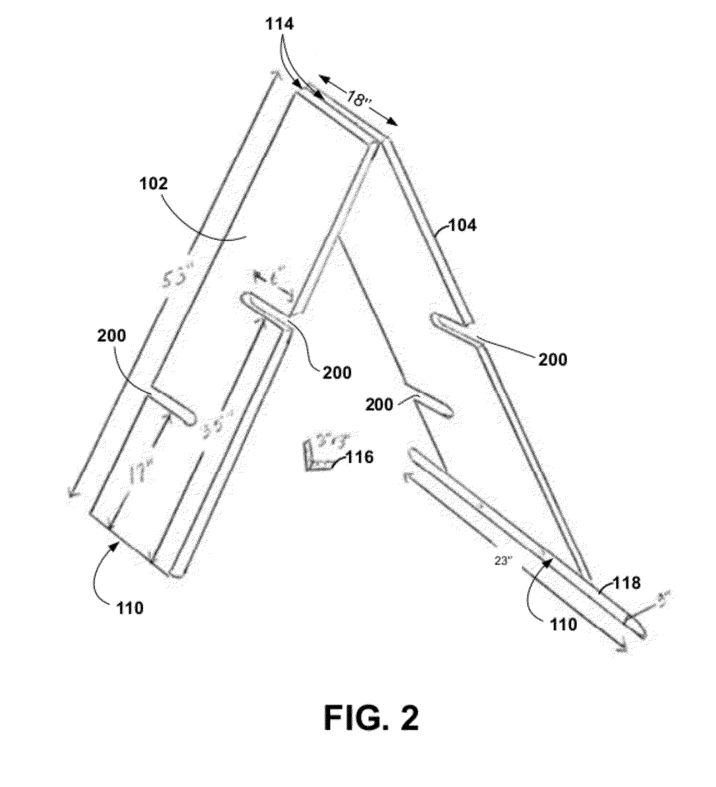

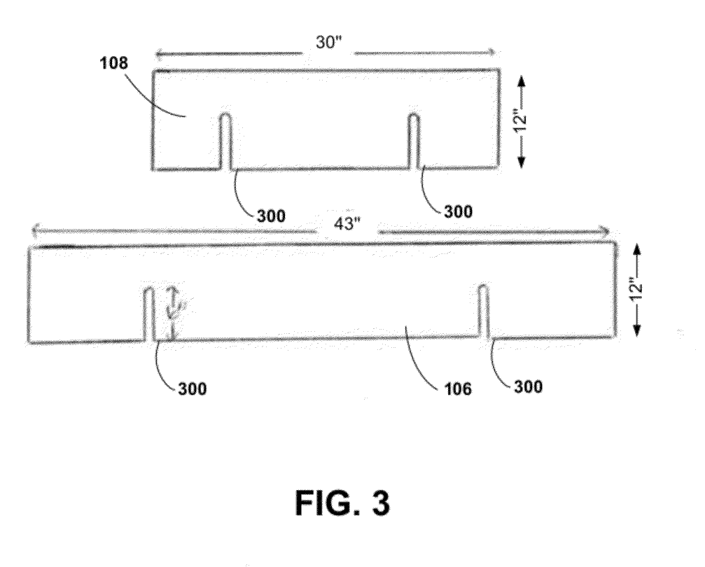

There are two metal hinges 112 attached with twelve screws to the frame members 102, 104 at ends 114. The hinges 112 attach the frame members 102, 104 to each other. The frame members 102, 104 have two notches 200 (FIG. 2) cut from the edges of the wood extending perpendicularly toward the center. The shelf members 106, 108 also have notches 300 (FIG. 3) extending toward their centers. In various embodiments, the notches 200, 300 can have various depths. For example, the notches 200, 300 can have depths of six inches. The notches 200 on the frame members 102, 104 are disposed on opposing sides. In various embodiments, the notches 200 are disposed at various distances from ends 110. For example, the notches 200 on the frame members 102 and 104 can be disposed at 17 and 35 inches from ends 110. In another example, the notches 200 on the frame members 102 and 104 can be disposed at 17 and 44 inches from the ends 110.

The notches 300 in the shelf member 106 are disposed on the same side of the shelf member 106. In various embodiments, the notches 300 in the shelf member 106 are disposed at various distances from the ends of the shelf member 106. For example, the notches 300 in the shelf member 106 can be disposed at 10 inches from each end of the shelf member 106. The shelf member 108 has notches that are disposed on the same side of the shelf member 108. In various embodiments, the notches 300 in the shelf member 108 are disposed at various distances from the ends of the shelf member 108. For example, the notches 300 in the shelf member 108 can be disposed at 8 inches from each end of the shelf member 108.

An example manufacturing process comprises cutting sheets of four foot by eight foot, ¾ inch plywood to the above specified dimensions to create the frame members 102, 104 and the shelf members 106, 108. The frame members 102, 104 and the shelf members 106, 108 are then covered in carpeting by means of a staple gun or other tool. Assembly done before shipment to a customer comprises attaching the two hinges 112 to the ends 114 of the frame members 102 and 104.

Once the customer receives the cat activity apparatus 110, the frame members 102, 104 are laid on their sides with the notches 200 closer to the hinged end 114 facing up. Then, the ends 110 would be moved approximately 35 inches apart to form a “V” shape. Next, the customer lines up the notches 300 on the shelf member 108 to the notches 200 facing up on the frame members 102 and 104. Once the notches 200 and 300 are lined up, the shelf member 108 would be inserted far enough that the plane of the front edge of the shelf member 108 is even or nearly even with the plane of the edge of the frame members 102 and 104. After that is accomplished, the customer stands the cat activity apparatus 100 upright and then lays the cat activity apparatus 100 down on its other side so that the notches 200 closer to ends 110 are facing up. The notches 300 on the shelf member 106 would then be lined up with the notches 200 facing up on the frame members 102 and 104. The customer then inserts the shelf member 106 into the notches 200 of the frame members 102 and 104 until the plane of the edge of the shelf member 106 is even with or nearly even with the plane of the edge of the frame members 102 and 104.

Furthermore, some embodiments include an L bracket 116. The “L” bracket can be three inches. The “L” bracket 116 can be used to attach the cat activity apparatus 100 to a wall to prevent the cat activity apparatus 100 from tipping.

In some embodiments, the customer attaches the stabilizer bar 118 to the bottom end of one of the frame members 102 or 104. The length of the stabilizer bar 118 is greater than the widths of the frame members 102, 104. For example, in some embodiments, the stabilizer bar 118 is 23 inch long, 3 inches wide, ¾ inch deep. The stabilizer bar 118 can prevent the cat activity apparatus 100 from tipping. The stabilizer bar 118 and/or the “L bracket” 116 are not necessarily present in embodiments where the frame members 102, 104 are sufficiently deep (e.g., 18 or more inches) to prevent the cat activity apparatus 100 from tipping.

In alternative designs, another stabilizer could include a removable cat scratching post attached to the lower and/or middle shelf members 106 and 108 extending to the floor, or a large diameter base that is attached to one or both of the ends 110 of the frame members 102 and 104. The length of the stabilizer scratching post would vary between 20 and 30 inches, and the diameter of the covered base would be approximately 24 inches.

The cat activity apparatus 100 is meant to be placed in an area where cats would enjoy it. The cat activity apparatus 100 is intended to be climbed on, jumped on, run on or through and laid or sat upon by cats providing them with entertainment, exercise, or relaxation. It is possible for cats to be interactive with each other, as well as their human companions. The cat activity apparatus 100 would be enjoyed by a single cat as well multiple cats. The cat activity apparatus 100 is designed to be easily disassembled for relocation or storage.

In other embodiments, the plywood may be replaced of a more earth-friendly material, such as recycled plastic, cardboard, or metal. The metal hinges 112 may be replaced by a heavy duty plastic interlocking device. Other embodiments may include things such as a scratching area. The scratching area can be made out materials including, but not limited to, sisal rope, burlap or cardboard. Furthermore, other embodiments can include a longer shelf with edges to form a bed or hammock and/or some variation of a bed on the top part of the unit. Larger and smaller embodiments exist. The measurements provided in this document are examples and do not represent the only possible measurements. For example, a larger embodiment can be approximately six feet in height and have three shelves. A smaller embodiment can be approximately three feet tall and have one shelf. Furthermore, some embodiments can have holes on the frame members 102, 104 large enough for cats to get through making a direct path from outside the “A” shape to inside.

What is claimed is:

1. A cat activity apparatus, comprising:
a first frame member;
a second frame member, the second frame member being attached to the first frame member at an end by a hinge mechanism to form “V” shape;
a first shelf member extending between the first frame member and the second frame member, the first shelf member being positioned in slots defined by the first frame member and the second frame member; and
a second shelf member extending between the first frame member and the second frame member and being vertically spaced from the first shelf member, the second shelf member being positioned in slots defined by the first frame member and the second frame member.

2. The apparatus of claim 1, further comprising a stabilizer bar coupled to the first frame member, the stabilizer bar having a width greater than that of the first frame member.
